(19) United States
(12) Patent Application Publication
(10) Pub. No.: US 2012/0102701 A1
(43) Pub. Date: May 3, 2012

(54) METHOD FOR REDUCING VIBRATION AMPLITUDES

(75) Inventors: Hans Peter Borufka, Starnberg (DE); Hernan Victor Arrieta, Munchen (DE); Andreas Hartung, Munchen (DE); Ulrich Retze, Eichenau (DE)

(73) Assignee: MTU AERO ENGINES GMBH, Munchen (DE)

(21) Appl. No.: 13/383,388

(22) PCT Filed: Jul. 7, 2010
(86) PCT No.: PCT/DE10/00783

§ 371 Date: Jan. 13, 2012

(30) Foreign Application Priority Data
Jul. 10, 2009 (DE) 10 2009 032 549.2

(51) Int. Cl. B23P 6/00; B23P 25/00

(52) U.S. Cl. 29/402.01; 29/33 R

(57) ABSTRACT

The English-language Abstract from the international application is to be retained and is therefore not duplicated in the specification.

### CROSS-REFERENCE TO RELATED APPLICATIONS

This application is a U.S. National Phase application submitted under 35 U.S.C. §371 of Patent Cooperation Treaty application serial no. PCT/DE2010/000783, filed Jul. 7, 2010, and entitled METHOD FOR REDUCING VIBRATION AMPLITUDES, which application claims priority to German patent application serial no. DE 10 2009 032 549.2, filed Jul. 10, 2009, and entitled VERFAHREN ZUM MINDERN VON SCHWINGUNGSAMPLITUDEN.

Patent Cooperation Treaty application serial no. PCT/DE2010/000783, published as WO 2011/003398, and German patent application serial no. DE 10 2009 032 549.2, are incorporated herein by reference.

### TECHNICAL FIELD

The present invention relates to a method and a device for reducing the vibration amplitude of a structure that is capable of vibrating, which structure can be excited to vibration by an excitation force. Structures that are capable of vibrating are particularly stator and rotor vanes of axial compressors or turbines, especially the blades thereof

### BACKGROUND

Rotor disks, and particularly the moving blades thereof, and stator disks, and particularly the guide vanes thereof, in axial compressors and turbines of gas turbine engines for aircraft or for other mobile or stationary applications are exposed to extreme conditions and must therefore satisfy extreme requirements. In particular, the vanes and especially the blades thereof must be able to withstand high centrifugal forces at high temperatures. At the same time, they should have a low mass and, for aerodynamic reasons, a thin profile.

The gas stream in which the moving blades rotate is inhomogeneous. Guide vanes or other devices disposed downstream and especially upstream modulate the pressure, speed and direction of the gas stream. The gas stream to which the guide vanes are exposed is also inhomogeneous. Moving blades or other devices rotating downstream and especially upstream modulate the pressure, speed and direction of the gas stream that strikes the guide vanes. Therefore, each individual vane is exposed to highly time-dependent forces. The time dependency of the forces is dependent particularly upon the number, geometry and configuration of the vanes in question and the vanes disposed upstream and downstream, and upon the speed and other parameters of the operating state.

Due to their elasticity, assembled and especially integrally bladed rotor and stator disks (bladed disks=BLISKs) are capable of vibrating. These disks have natural vibration modes and associated resonance frequencies. When the forces acting on a rotor or stator disk have components that oscillate at a characteristic frequency for the rotor or stator disk, the associated natural vibration mode of the rotor or stator disk is excited. In this resonance situation, high vibration amplitudes and corresponding mechanical stresses for the rotor disk, particularly the vanes and the blades thereof, can result. In extreme cases, the rotor disk, particularly the blades, can become damaged or destroyed.

U.S. Pat. No. 4,722,668 describes a damping of blade vibrations using magnets disposed on the shroud band or at the center of the blades. The magnets are arranged such that magnets disposed on neighboring blades are opposite one another and attract one another.

U.S. 5,490,759 describes a magnetic damping system for limiting blade tip vibrations in turbo machines. When blade vibrations occur, electromagnets are activated. Eddy currents induced in the blade tips damp the blade vibrations.

### SUMMARY AND DESCRIPTION

One problem addressed by the present invention is that of providing improved methods and devices along with a control mechanism and a computer program for reducing the vibration of a structure that is capable of vibrating.

This problem is addressed by the subjects of the independent claims.

Further developments are indicated in the dependent claims.

Various embodiments of the present invention are based upon the knowledge that the above-described conventional methods and devices do not reduce the excitation of vibrations, and instead damp vibrations that have already been excited, and upon the idea of counteracting the excitation rather than damping vibrations that have already been excited, as has heretofore been the case. With the conventional methods and devices described in the introductory portion, a movement of a vane or a blade induces eddy currents, which generate forces that are directed opposite to the movement. In contrast, in the present case a counterforce to an excitation force that excites a vibration is generated. The counterforce is directed at least predominantly opposite to the excitation force, in order to at least partially compensate for it. The excitation of a vibration is thereby reduced.

The effect of unavoidable unsteady, particularly aerodynamic excitation forces or excitation fields on the structure that is capable of vibrating, more particularly, on the vane or the blade, is therefore altered. This change in the effect occurs as a result of mistuning, particularly of the amplitude of the excitation force, particularly as a result of at least partial compensation of the excitation force by a counterforce which is directed predominantly opposite to the excitation force.

In a method for reducing the vibration of a structure that is capable of vibrating, which structure can be excited to vibration by an excitation force, first at least either a position dependency or a time dependency of an excitation force which acts on the structure and is capable of exciting a vibration of the structure is determined. A counterforce is generated such that the counterforce is directed predominantly opposite to the excitation force and therefore at least partially compensates for the excitation force, in order to reduce the excitation of a vibration.

In this, a displacement of the structure that is capable of vibrating can be detected, and the counterforce can be generated on the basis of the detected displacement. Thus, for example, in the case of minor displacements, the generation of a force can be dispensed with, in order to save on the amount of power required. The determination step can comprise an empirical detection or a numerical simulation of the excitation force.

The method can particularly be applied to stator vanes, stator disks, stator stages, rotor blades, rotor disks, rotor stages or other structures that are capable of vibrating, which are embodied for rotation about an axis. In this case, the position dependency of the excitation force is particularly an angular dependency.

With rotating structures that are capable of vibrating, at least either a speed or an angular position of the structure can be determined, and data relating to at least either the angular dependency or the time dependency of the excitation force or of a counterforce that is necessary for the at least partial compensation of the excitation force at the detected speed or angular position can be read out of a data memory. The counterforce can be produced by a magnetic field, which is generated by means of a permanent magnet or electromagnet. The action of the magnetic field can be based upon magnetostatic attraction or repulsion, for example, and/or upon interaction with induced eddy-current fields. The latter case involves a new form of eddy current damping.

A device for reducing the vibration of a structure that is capable of vibrating, which structure can be excited to vibration by an excitation force, comprises an active device for generating a counterforce such that the counterforce is directed predominantly opposite to the excitation force and particularly compensates at least partially for the excitation force, in order to reduce the excitation of a vibration.

The active device can be disposed either on the structure that is capable of vibrating or, for example, opposite thereof. Alternatively, the active device can comprise a plurality of parts, one of which can be disposed on the structure that is capable of vibrating, and one of which can be disposed opposite the structure that is capable of vibrating, for example. The active device comprises, for example, a magnet for generating a magnetic field, a device for generating electrostatic attraction or repulsion or a device for generating fluid dynamic forces.

The device can further comprise a sensor for detecting at least either a displacement or a vibration amplitude or a speed or an angular velocity or an angular position or a velocity or a position of the structure that is capable of vibrating or a temperature or a pressure or a density of a fluid. The device can further comprise a data memory for storing at least either a position dependency or a time dependency of the excitation force or the counterforce that is necessary for the at least partial compensation of the excitation force. The device can further comprise a control mechanism for reading out data from the data memory on the basis of at least either a speed or an angular velocity or a velocity or an angular position or a position of the structure or a temperature or a pressure or a density of a fluid and for controlling the active device on the basis of data that are read out of the data memory.

A number of embodiments can also be characterized such that a vibration of a structure that is capable of vibrating, which structure can be excited to vibration by an excitation force, is reduced in that the structure that is capable of vibrating is simultaneously excited in phase opposition to excitation by the excitation force, wherein the excitation by the excitation force is at least partially compensated for by the counter-phase excitation. In other words, a defined, first excitation with a certain first phase is at least partially compensated for by an additional, second excitation with an opposite second phase (phase difference between the first phase and the second phase equal to 180° or pi). The effective or remaining excitation is thereby reduced. This results in reduced displacements, amplitudes and stresses for the structure that is capable of vibrating.

In a further method for reducing the vibration of a structure that is capable of vibrating, which structure can be excited to vibration by an excitation force, a force having a stochastic or quasi-stochastic or pulse-like position dependency or time dependency is generated, in order to reduce the excitation of a vibration.

A further device for reducing the vibration of a structure that is capable of vibrating, which structure can be excited to vibration by an excitation force, comprises a device for generating a force having a stochastic or quasi-stochastic or pulse-like position dependency or time dependency, in order to reduce the excitation of a vibration.

With the latter method and with the latter device, the force is particularly less dependent upon the velocity than upon the position or the deformation state of the structure, and is therefore distinguished from damping forces that are dependent predominantly upon the velocity of the movement or the deformation of a structure that is capable of vibrating.

The above-mentioned force having a stochastic or quasi-stochastic or pulse-like position dependency or time dependency, like the counterforce described above that is directed predominantly opposite to the excitation force, can be generated by one or more electric, magnetic or electromagnetic fields that are static or vary over time. The force effect of the electric, magnetic or electromagnetic field or fields is based, for example, upon electrostatic or magnetostatic attraction or repulsion and/or upon interaction with induced eddy current fields.

The above-mentioned force having a stochastic or quasi-stochastic or pulse-like position dependency or time dependency can have an axial component (parallel to the engine axis) and/or a tangential component (in the direction of the periphery). The above-described counterforce directed predominantly opposite to the excitation force, a force having a stochastic or quasi-stochastic position dependency or time dependency and/or a force having a pulse-like position dependency or time dependency can be used separately or in any combination.

The devices described above can particularly be embodied for implementing one of the above-described methods. The above-described methods can particularly be implemented using one of the above-described devices.

A control mechanism for reducing the vibration of a structure that is capable of vibrating, which structure can be excited to vibration by an excitation force, comprises a control output for controlling an active device for generating a counterforce such that the counterforce is directed predominantly opposite to the excitation force, and particularly compensates at least partially for the excitation force in order to reduce the excitation of a vibration. For example, the control mechanism is integrated into a turbine control device (engine control unit) or is identical thereto.

A computer program for reducing the vibration of a structure that is capable of vibrating, which structure can be excited to vibration by an excitation force, comprises a program code for carrying out or controlling one of the above-described methods when the computer program is run on a computer or a processor.

The present invention is particularly suitable for use with axial compressors, turbines, gas turbine engines for aircraft and other mobile or stationary applications. Vibrations of both assembled and integrally bladed rotor or stator disks having a shroud band or in an embodiment without shroud band and on corresponding rotor or stator stages can be reduced. The invention is suitable for vanes or blades made of non-magnetic or magnetic materials, for example.

Furthermore, however, the present invention can also be applied to many other structures that are capable of vibrating, on which, on the basis of a rotation thereof or of another component, or on the basis of a linear movement, or for other reasons, a force acts which can excite a vibration. A structure that is capable of vibrating can comprise a single integrally produced component or a component composed of a plurality of parts or a group of components that are coupled to one another. A vibration refers especially to a periodically or approximately periodically oscillating elastic deformation of the structure or of a part of the structure, or a periodic or approximately periodic movement of the structure on the basis of an elastic mechanical or other suspension.

In many cases a constant force or a constant component of a varying force is not suitable for exciting a vibration. Therefore, an excitation force or a force that excites a vibration refers particularly to a force that varies as a function of time or position, or a component of a force that varies as a function of time or position. At the temporal or positional mean, the excitation force can therefore be zero. The term “force” also comprises a force field and a plurality of forces. Multiple forces can act at different locations, and thereby generate a torque or a greater momentum. A force also refers to a torque or a greater momentum which is exerted by an active device on the structure that is capable of vibrating, regardless of whether this momentum is generated by a plurality of forces acting at different locations.

A number of embodiments of the present invention have the advantage that instead of damping vibrations that have already been excited, the excitation of vibrations can be reduced. Whereas with conventional methods as described in the introductory portion, damping is greater the greater the amplitude of the displacement and the amplitude of the velocity, embodiments of the present invention are suitable for suppressing even small displacements or small vibrations.

### BRIEF DESCRIPTION OF THE FIGURES

In what follows, embodiments will be specified in greater detail in reference to the attached set of drawings. The drawings show:

FIG. 1 a schematic illustration of a blade;

FIG. 2 a schematic illustration of a deformation of the blade of FIG. 1 in a first vibration mode;

FIG. 3 a schematic illustration of a deformation of the blade of FIG. 1 in a second vibration mode;

FIG. 4 a schematic illustration of a deformation of the blade of FIG. 1 in a third vibration mode;

FIG. 5 a schematic illustration of a device for reducing a vibration; and

FIG. 6 a schematic flow chart of a method for reducing a vibration.

### DETAILED DESCRIPTION

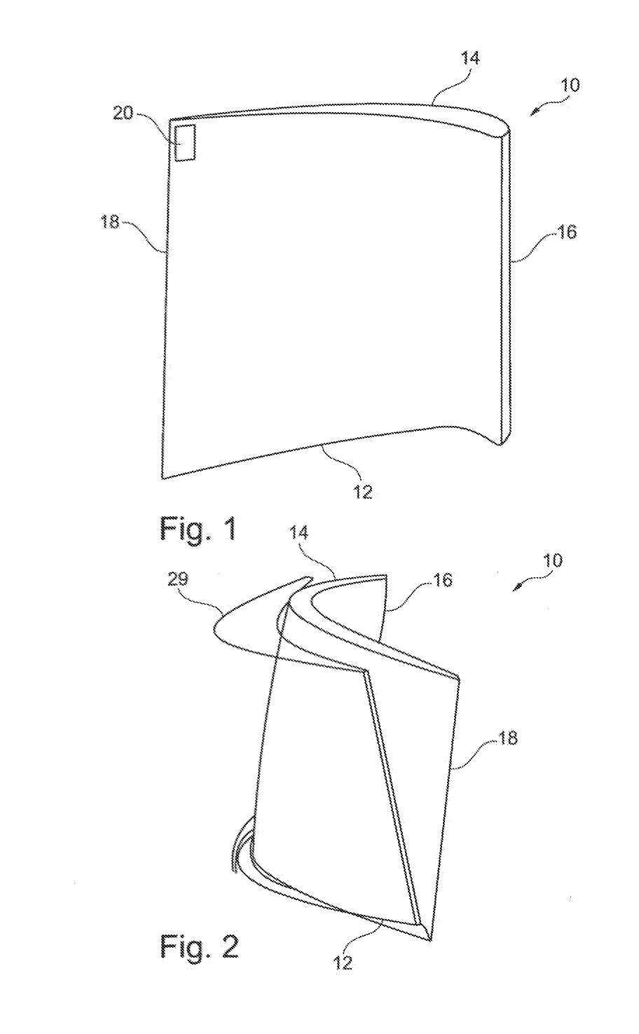

FIGS. 1 to 4 each show a schematic illustration of a blade 10 or a vane of a turbine blade. The blade 10 can be a component of a moving vane or of a rotor disk or of a rotor stage or of a guide vane or of a stator disk or of a stator stage. The illustrated blade 10 has no shroud band. However, the following embodiments can also be used with a moving blade that has a shroud band.

The blade 10 has a fixed end or attached end 12 and an unattached end 14. On the attached end 12, the blade 10 transitions across a platform to a blade root, for example. Platform, blade root, disk ridge, disk segment and other components of the blade or the turbine disk or the turbine stage are not shown in FIGS. 1 to 4. The blade 10 further has a leading edge 16 and a trailing edge 18. Also shown in FIG. 1 is a magnet 20 at the unattached end 14 near the trailing edge 18 of the blade 10, which will be described further below.

FIGS. 2 to 4 show schematic illustrations of snapshots of the blade 10 in various vibration modes. In each case, the shape of the non-deformed blade is indicated by an outline 29. The illustrations are based upon numerical simulations having a complete three-dimensional blade model, which in addition to the blade 10 also comprises a blade root, a disk ridge and a disk segment. Accordingly, in each case a slight deformation is visible at the attached end 12 of the blade 10. Because the components not shown in the figures, particularly the blade root, the disk ridge and the disk segment, are more rigid than the blade 10, the deformations of the blade 10 at the attached end 12 are significantly less than at the unattached end 14.

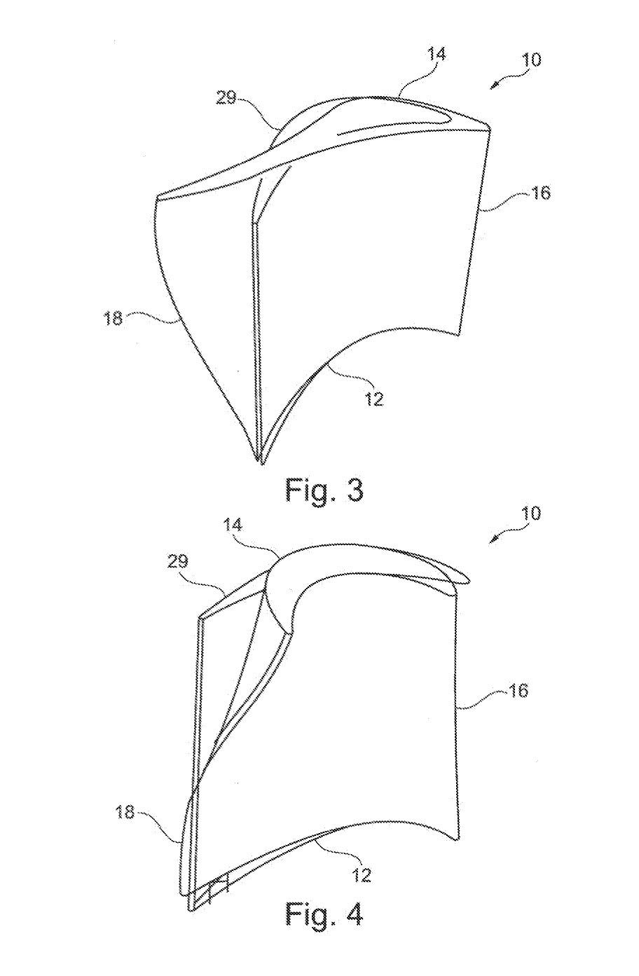

The illustrated natural vibration modes are three different fundamental vibration forms. FIG. 2 shows a snapshot of the first flexural vibration, FIG. 3 shows a snapshot of the first torsional vibration, and FIG. 4 shows a snapshot of the first chordal vibration. In each case, the illustrated deformations are exaggerated for purposes of clarity.

The tuning of a vane in terms of vibration mechanics, particularly of a blade 10 in the operating range (speed, temperature, pressure, etc.) of the turbo machine of which the blade 10 is a component, which tuning is necessary for satisfying requirements relating to structural mechanical integrity, is generally carried out as an interdisciplinary iterative process. Said process incorporates aerodynamics, structural mechanics, structural engineering, and experimental validation.

The excitation of resonances or resonance frequencies and the associated natural vibration modes can cause strong vibration amplitudes, correspondingly severe structural stresses, and as a result, damage to or destruction of the blade 10 or the entire vane. Therefore, the vanes and particularly the blade 10 are structured as necessary such that resonance frequencies at least of the fundamental natural vibration modes lie outside of the operating range or are not excited by oscillating forces occurring in the operating range. If this is not possible, conventional damping systems are used. These are based upon mechanical friction, the generation of eddy currents or of magnetic fields by inverse magnetostriction, from which energy is drawn in magnetostrictive materials or by eddy currents.

As was already mentioned in the introductory portion, the effect of unavoidable unsteady, particularly aerodynamic excitation forces or excitation fields on the structure that is capable of vibrating, particularly on the blade 10, is altered in the invention. This alteration of the effect is carried out by mistuning, particularly of the amplitude of the excitation force, particularly by at least partially compensating for the excitation force by means of a counterforce, which is directed predominantly opposite to the excitation force.

The position dependency and the time dependency of the excitation forces of an aerodynamic nature acting on the blade 10 can be determined by means of a numerical simulation or can also be empirically detected. Further, forces that are necessary or suitable for exciting natural vibration modes and the position dependency and time dependency thereof can also be determined, again empirically or via numerical simulation.

The excitation of a vibration mode can be carried out most efficiently using a force that acts at a location of maximum displacement. As is clear from FIGS. 2 to 4, for the first flexural vibration this is a location at the unattached end 14 of the blade 10, for example at the center of the unattached end 14, and for the first torsional vibration, this is a location at the unattached end 14 near the trailing edge 18 and/or near the leading edge 16.

In the above-described FIG. 1, a magnet 20 is shown at the unattached end 14 near the trailing edge 18 of the blade 10. When the magnet 20 is exposed to a magnetic alternating field having a suitable direction, and the magnetic alternating field is oscillating at a frequency that corresponds to the resonance frequency or characteristic frequency at the first torsional vibration, this natural vibration mode can be excited by the magnetic alternating field. If the frequencies at which the magnetic alternating field is oscillating correspond to the resonance frequency or characteristic frequency of the first flexural vibration, this natural vibration mode can be excited by means of the magnet 20. If the frequency at which the magnetic alternating field is oscillating corresponds to the resonance frequency or characteristic frequency of the first chordal vibration, this natural vibration mode can be excited.

When the characteristic frequencies for different natural vibration modes are the same or similar, however, a plurality of natural vibration modes can be excited simultaneously by means of the magnets 20 with a magnetic alternating field of corresponding frequency. This can be prevented, for example, by positioning a second magnet at the unattached end 14 near the leading edge 16 or at the center of the unattached end 14, or by positioning a second and a third magnet at the center or near the leading edge 16 at the unattached end 14 of the blade 10. With the orientation of these two or three magnets and the direction of the magnetic alternating field at the locations of the magnets, forces having different directions can be exerted simultaneously by the magnets on the unattached end 14 of the blade 10.

When the forces exerted via the magnetic alternating field by the magnets situated at the unattached end 14 on the leading edge 16, on the trailing edge 18 and at the center between these have the same direction, the first flexural vibration is excited. When the forces exerted by the magnetic alternating field via the magnets situated at the unattached end 14 of the blade 10 have opposite directions on the leading edge 16 and on the trailing edge 18, the first torsional vibration is excited. When the forces exerted by the magnetic alternating field by the magnets at the unattached end 14 of the blade 10 have the same direction on the leading edge 16 and the trailing edge 18, and between these, at the center, have an opposite direction, the first chordal vibration is excited. By orienting the magnets and/or the magnetic alternating field differently at the locations of the magnets, and by using a larger number of magnets, additional natural vibration modes not shown in FIGS. 2 to 4 can be excited.

The magnetic alternating field can be generated by means of a magnetic coil, in which a corresponding alternating current flows. Alternatively, the magnetic alternating field can be generated by permanent magnets or by magnetic coils through which direct current flows, which are positioned near the periphery of the circle which is swept by the rotating blade 10. If the blade 10 is part of a stator vane or a stator disk, on the inner circumference of which the unattached end 14 of the blade 10 is disposed, or is a corresponding stator stage, the magnetic alternating field to which the magnet 20 is exposed can be generated by permanent magnets or by magnetic coils through which direct current flows, said magnetic coils being rotated by a rotor.

According to the present invention, the magnet 20 and optionally additional magnets on the blade 10 and the magnetic alternating field are arranged and oriented such that the above-described excitation of the natural vibration modes is carried out in phase opposition to an excitation by the aerodynamic excitation forces, described in the introductory portion. Excitation by the aerodynamic excitation forces and excitation via the magnetic field and the magnet or magnets 20 on the blade 10 compensate at least partially for one another, so that the vibration modes together are excited more weakly or significantly more weakly, or even are not excited at all. An excitation in phase opposition in this case means a phase difference between the aerodynamic excitation forces and the described magnetic excitation of 180° or π (pi). Therefore, a counterforce is produced by way of the magnetic field and the magnets 20, which force is directed opposite to the aerodynamic excitation force, in order to at least partially compensate for it and therefore at least reduce excitation.

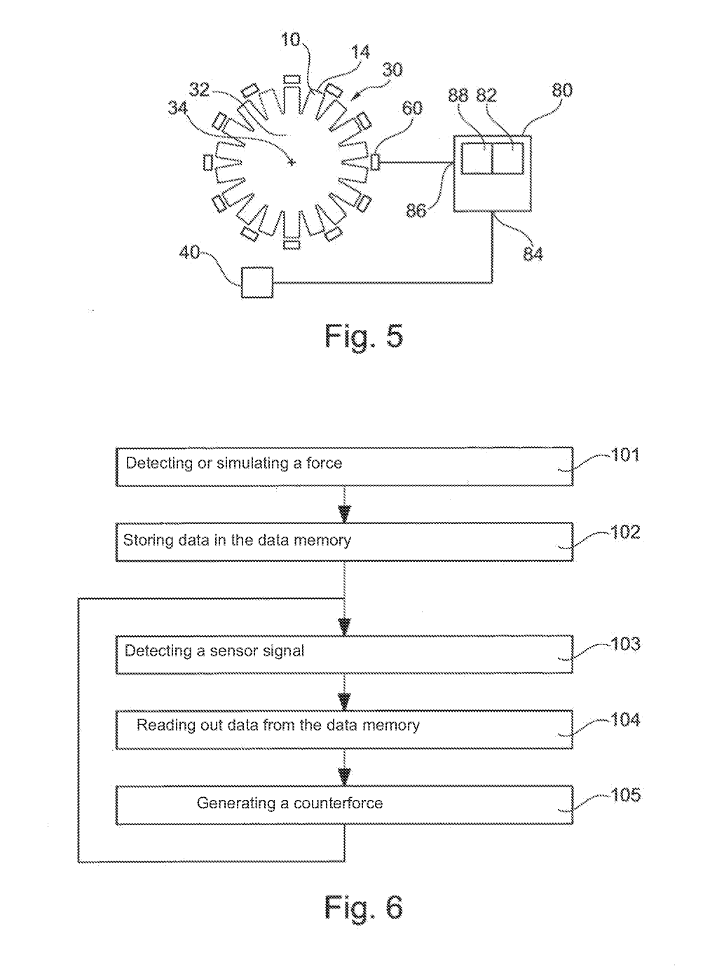

FIG. 5 shows a schematic illustration of a bladed rotor disk 30 having a central element 32 on which a plurality of blades 10, such as were described above in reference to FIGS. 1 to 5, is arranged. The bladed rotor disk 30 is capable of rotating about an axis 34.

A sensor 40 is embodied, for example, for detecting the speed or as an equivalent the angular velocity and/or the angular position. For this purpose, said sensor is connected, for example, to a shaft that is not shown in FIG. 6, or is optically or magnetically coupled to the bladed rotor disk 30.

On the periphery of the bladed rotor disk 30, near the unattached ends 14 of the blades 10, active devices 60 are arranged, particularly permanent magnets or electromagnets. The number and arrangement of the active devices 60 correspond particularly to the number and arrangement of neighboring stator vanes upstream or also downstream. In the interest of a clear illustration, only one active device 60 is identified by a reference sign.

A control mechanism 80 comprises a data memory 82, a sensor input 84, a control output 86 and a processor 88. The sensor input 84 of the control mechanism 80 is coupled to the sensor 40. The control output 86 of the control mechanism 80 is coupled to the active device 60. In the interest of a clear illustration, the coupling of only one active device 60 to the control output 86 is shown. The sensor 40, the active devices 60 and the control mechanism 80 together form a device for reducing vibrations of the integrally bladed rotor disk 30 and particularly of blades 10 of the bladed rotor disk 30. Because the bladed rotor disk 30 can be, but need not necessarily be, a component of this device, it is illustrated by dashed lines. The control mechanism 80 is integrated into or is identical to a turbine control device (engine control unit), for example.

When the bladed rotor disk 30 rotates, the control mechanism 80 detects the speed or angular velocity and/or the angular position of the bladed rotor disk 30 by way of the sensor 40. On the basis of the parameters detected via the sensor, the control mechanism 80 controls the active devices 60. For example, the control mechanism 80 activates the active devices 60 only in one or more speed ranges in which otherwise, as a result of the excitation forces described in the introductory portion, resonances of the blades 10, for example, the natural vibration modes described above in reference to FIGS. 2 to 4, would be excited. To take into consideration the influence of rotor disks rotating at other speeds, the control mechanism 80 can accordingly modulate the forces exerted by the active devices 60 at the unattached ends 14 of the blades 10 of the integrally bladed rotor disk 30. Speed ranges or other operating parameters on the basis of which the active devices 60 are to be controlled, and parameters for controlling the active devices 60 can be stored in the memory 82 of the control mechanism 80.

The control mechanism 80 and the sensor 40 can be dispensed with if the active devices 60 are permanent magnets or other devices that do not require a control mechanism.

Rather than the described arrangement of the active devices 60 in accordance with the arrangement of neighboring guide vanes upstream and/or downstream, or other devices that influence the gas stream, the active devices 60 can also be arranged stochastically or quasi-stochastically or deterministically. In this case, the active devices 60 exert forces on the unattached ends 14 of the blades 10 of the integrally bladed rotor disk 30 and excite the blades 10 in such a way that excitation generated by the excitation forces described in the introductory portion are disrupted and therefore reduced. This is possible, for example, when, due to a non-linear elasticity of the integrally bladed rotor disk 30 or the blades 10 thereof, an interaction, particularly an energy exchange between vibration modes, occurs.

When the active devices interact directly with the blades 10, the blades 10 need no magnets 20. This is the case, for example, when the blades 10 are paramagnetic or ferromagnetic, or when the counterforces are generated by eddy currents in the blades 10, which are produced by the active devices 60. Rather than permanent magnets or electromagnets, the active devices 60 can also contain other devices which interact electrostatically or fluid dynamically, for example, with the blades 10, particularly with the unattached ends 14 thereof

One configuration that corresponds to FIG. 5 is also possible for a stator disk, in which attached ends of blades are arranged on the outer circumference of the stator disk, and unattached ends of blades are arranged on the inner circumference thereof. In this case, the active devices 60 are arranged on an adjacent rotor disk or a drum, for example, near the unattached ends of the blades, so as to rotate with the rotor blades which generate the oscillating forces acting on the stator vanes as described in the introductory portion. A configuration that corresponds to FIG. 5 is also possible for a stator stage or a rotor stage. However, applications for other rotating, linearly moved or stationary structures, which are exposed to oscillating excitation forces, are also possible.

In contrast to the illustration of FIG. 5, the active devices can also be arranged on the blades 10 or can have parts that are disposed on the blades 10 and parts that are disposed opposite the blades 10, for example. More particularly, magnetic coils or permanent magnets can be arranged on the blades 10 and/or opposite thereof on a housing or other apparatus not illustrated in FIG. 5.

Rather than a regular arrangement of the active devices 60, as indicated in FIG. 5, the active devices 60 can also be arranged stochastically or quasi-stochastically, in order to generate a force having a stochastic or quasi-stochastic position dependency. If the active devices 60 are electromagnets or other active devices having a force effect that is controllable on the basis of time, then with a regular or stochastic or quasi-stochastic arrangement, said devices can be controlled by means of the control mechanism 80 in such a way that each individual active device 60 generates a force having a stochastic or quasi-stochastic or pulse-like time dependency. In the case of electromagnets, currents having a correspondingly stochastic or quasi-stochastic or pulse-like time dependency flow through these.

The force having the stochastic or quasi-stochastic and/or pulse-like time dependency and/or position dependency disrupts the development of vibrations in the structure that is capable of vibrating and therefore reduces the vibration of the structure that is capable of vibrating or the amplitude of this vibration.

Both the counterforce and the force having a stochastic or quasi-stochastic or pulse-like time dependency and/or position dependency can each have portions or components in the axial direction or parallel to the axis 34 and portions or components in the circumferential direction or the direction perpendicular to the axis 34.

FIG. 6 shows a schematic flow chart of a method for reducing the vibration of a structure that is capable of vibrating, which structure can be excited to vibration by an excitation force. Although this method can also be applied to structures that are capable of vibrating which are different from the blades described above in reference to FIGS. 1 to 4, and can also be implemented using devices that are different from the device described above in reference to FIG. 5, in what follows, reference signs from FIGS. 1 to 5 are used, in the interest of clarity.

In a first step 101, an excitation force which can excite the structure 10 that is capable of vibrating to vibration is empirically detected or is determined by numerical simulation. In a second step 102, data about the time dependency, position dependency, or angular dependency of the excitation force determined in the first step 101 are stored in a data memory 82. Alternatively, in the second step 102 data are stored in the data memory, which data characterize a counterforce that is necessary for the at least partial compensation of the excitation force, particularly the time dependency, position dependency or angular dependency thereof. The first step 101 and the second step 102 can be carried out before operation of the structure that is capable of vibrating, particularly before said structure is first placed in operation, and can be repeated when maintenance is performed on the structure that is capable of vibrating, for example.

In a third step 103, a sensor signal from a sensor 40 is detected and with it, an operating parameter is determined. More particularly, a speed, an angular position, an angular velocity, a displacement, a vibration amplitude, a velocity, a temperature, or a pressure is detected. In a fourth step 104, on the basis of the determined operating parameter, data are read out of the data memory 82. In a fifth step 105, on the basis of the data read out of the data memory 82 in the fourth step 104, a counterforce is generated, for example, by controlling active devices 60. The third step 103, the fourth step 104 and the fifth step 105 are executed continuously or are repeated periodically, for example.

For example, in the fifth step 105, the active devices are activated only when a critical operating state is present in which a resonance or a natural vibration mode of the structure that is capable of vibrating can be excited.

The data in the data memory 82 can also be used in the fifth step 105 to arrange permanent magnets or other active devices that cannot or need not be controlled in such a way that the counterforces are generated. In this case, the third step 103 and the fourth step 104 are omitted.

In an alternative method for reducing the vibration of a structure that is capable of vibrating, which structure can be excited to vibration by an excitation force, a force having a stochastic or quasi-stochastic or pulse-like position dependency and/or time dependency is generated. The force is carried out by stochastically or quasi-stochastically arranged permanent magnets, for example, in order to generate a stochastic or quasi-stochastic position dependency of the force. Alternatively or additionally, the force is generated, for example, by one or more electromagnets, through which one or more different currents having stochastic or quasi-stochastic time dependency flow.

Rather than a force having a stochastic or quasi-stochastic position dependency and/or time dependency, or in addition to this, a force having a pulse-like position dependency and/or time dependency can be generated. In addition, particularly a corresponding arrangement of permanent magnets or an arrangement of one or more electromagnets, through which one or more different currents having a corresponding time dependency flow, is used.

The force having the stochastic or quasi-stochastic and/or pulse-like time dependency and/or position dependency disrupts the development of vibrations of the structure that is capable of vibrating and therefore reduces the vibration of the structure that is capable of vibrating or the amplitude of this vibration.

The method described above in reference to FIG. 6 can be combined with the described method in which a force having a stochastic or quasi-stochastic time dependency and/or position dependency acts on the structure that is capable of vibrating. The counterforce and the force having the stochastic or quasi-stochastic or pulse-like time dependency or position dependency can be generated simultaneously or alternatingly by the same active devices or by different groups of active devices.

In one variant of the described method, the operating point of a turbo compressor or axial compressor is monitored. Shortly before an unstable operating point is reached, at which pumping can occur, a structure that is capable of vibrating is excited to vibration. The pump stroke is therefore disrupted as an excitation. For example, the pump stroke is generated somewhat outside of the unstable range or at the boundary of the unstable range. The pump stroke is thereby smaller and less vigorous. As a result, the risk of damage to the turbo compressor or axial compressor is reduced.

The present invention can be implemented as a method or as a computer program having a program code for carrying out or controlling a method of this type, when the computer program is run on a computer or a processor. The invention can also be implemented as a computer program product having a program code that is stored on a machine-readable carrier (for example, a ROM-, PROM-, EPROM-, EEPROM- or flash memory, a CD-ROM, DVD, HD-DVD, Blue-Ray DVD, diskette or hard drive) or is stored in the form of firmware, for carrying out one of the stated methods when the computer program product is run on a computer, computing machine or processor. The present invention can also be implemented as a digital storage medium (for example, a ROM-, PROM-, EPROM-, EEPROM- or flash memory, a CD-ROM, DVD, HD-DVD, Blue-Ray DVD, diskette or hard drive) having electronically readable control signals, which can interact with a programmable computer or processor system such that one of the described methods is executed.

The present invention can further be implemented as a control mechanism, wherein the control mechanism is embodied for executing one of the described methods. The control mechanism can comprise a computer program, a computer program product or a digital storage medium, as described in the preceding paragraph.

1-17. (canceled)

18. A method for reducing the vibration of a structure that is capable of vibrating, which structure can be excited to vibration by an excitation force, said method comprising the following steps:
determining at least either a position dependency or a time dependency of an excitation force that acts on the structure and is capable of exciting a vibration of the structure; and
generating a counterforce in such a way that the counterforce is directed predominantly opposite to the excitation force, in order to reduce the excitation of a vibration.

19. A method according to claim 18, wherein:
a displacement of the structure that is capable of vibrating is detected; and
the counterforce is generated on the basis of the detected displacement.

20. A method according to claim 18, wherein the step of determining comprises at least one of:
an empirical detection of the excitation force; or
a numerical simulation of the excitation force.

21. A method according to claim 18, wherein:
the structure that is capable of vibrating is configured for rotation about an axis; and
the position dependency is an angular dependency.

22. A method according to claim 18, further comprising the following steps:
detecting at least one of a speed or an angular velocity or an angular position or a velocity or a position of the structure or a temperature or a pressure or a density; and
reading out data relating to at least either the angular dependency or the time dependency of the excitation force or the counterforce at the detected speed or angular velocity or angular position or velocity or position of the structure or temperature or pressure or density from the data memory.

23. A method according to claim 18, wherein the step of generating a counterforce comprises generating a magnetic field by at least one of a permanent magnet or an electromagnet.

24. A method according to claim 18, further comprising the step of generating a force having a stochastic or quasi-stochastic or pulse-like or other predefined position dependency or time dependency, in order to reduce the excitation of a vibration.

25. A method according to claim 18, further comprising the following steps:
providing a device for reducing the vibration of a structure, the device including
an active device adapted to selectively generate a counterforce that is directed predominantly opposite to the excitation force,
a sensor adapted to detect at least either a displacement or a vibration amplitude or a speed or an angular position or a velocity or a position of the structure that is capable of vibrating or a temperature or a pressure or a density,
a data memory adapted to store at least either a position dependency or a time dependency of the excitation force or the counterforce, and
a control mechanism, the control mechanism adapted to
read out data from the data memory on the basis of at least either a speed or a velocity or an angular velocity or an angular position of the structure, and
control the active device on the basis of data read out from the data memory,
wherein the sensor is used in performing the step of determining at least either a position dependency or a time dependency of an excitation force; and
wherein the control mechanism and the active device are used in performing the step of generating a counterforce.

26. A device for reducing the vibration of a structure that is capable of vibrating, which structure can be excited to vibration by an excitation force, the device comprising:
an active device adapted to selectively generate a counterforce that is directed predominantly opposite to the excitation force.

27. A device for reducing vibration according to claim 26, wherein the active device comprises a magnet selectively generating a magnetic field.

28. A device for reducing vibration according to claim 26, further comprising a sensor adapted to detect at least either a displacement or a vibration amplitude or a speed or an angular position or a velocity or a position of the structure that is capable of vibrating or a temperature or a pressure or a density.

29. A device for reducing vibration according to claim 26, further comprising a data memory adapted to store at least either a position dependency or a time dependency of the excitation force or the counterforce.

30. A device for reducing vibration according to claim 29, further comprising a control mechanism, the control mechanism adapted to:
read out data from the data memory on the basis of at least either a speed or a velocity or an angular velocity or an angular position of the structure; and
control the active device on the basis of data read out from the data memory.

31. A device for reducing vibration according claim 26, further comprising:
a device adapted to generate a force having a stochastic or quasi-stochastic or pulse-like or other predefined position dependency or time dependency, in order to reduce the excitation of a vibration.

32. A device for reducing vibration according to claim 26, wherein the device is adapted to:
determine at least either a position dependency or a time dependency of an excitation force that acts on the structure and is capable of exciting a vibration of the structure; and
generate a counterforce in such a way that the counterforce is directed predominantly opposite to the excitation force, in order to reduce the excitation of a vibration.

33. A device for reducing vibration according to claim 26, further comprising:
a digital storage medium for storing machine-readable information, the digital storage medium including
instructions for execution on an operably-connected device for determining at least either a position dependency or a time dependency of an excitation force that acts on a structure and is capable of exciting a vibration of the structure; and
instructions for execution on the operably-connected device for generating the counterforce that is directed predominantly opposite to the excitation force.

34. A device for reducing vibration according to claim 33, wherein the digital storage medium is at least one of a ROM, a PROM, an EPROM, an EEPROM, a flash memory, a CD-ROM, a DVD, a HD-DVD, a Blue-Ray DVD, a diskette, and a hard-disk drive.

35. A control mechanism for reducing the vibration of a structure that is capable of vibrating, which structure can be excited to vibration by an excitation force, the control mechanism comprising:
a control output for controlling an active device for generating a counterforce, such that the counterforce is directed predominantly opposite to the excitation force, in order to reduce the excitation of a vibration.
